(19) United States
(12) Patent Application Publication
(10) Pub. No.: US 2007/0071872 A1
(43) Pub. Date: Mar. 29, 2007

(54) Balanced vegetable oil composition

(75) Inventors: Jean-Pierre Goeseels, Bastogne (BE); Claude Remacle, Loyers (BE); Philippe Bourgies, Anhee (BE); Jean-Francois Thiry, Bastogne (BE); Philippe Dejardin, Trooz (BE); Fabien De Meester, Marche-en-Famenne (BE)

Correspondence Address: MERCHANT & GOULD PC, P.O. BOX 2903, MINNEAPOLIS, MN, 55402-0903, US

(73) Assignee: Belovo S.A., Bastonge (BE)

(21) Appl. No.: 10/570,476

(22) PCT Filed: Sep. 1, 2004
(86) PCT No.: PCT/BE04/00125

§ 371 Date: Nov. 30, 2006

(30) Foreign Application Priority Data
Sep. 1, 2003 (EP) 03447221.7

(51) Int. Cl. A23D 9/00

(52) U.S. Cl. 426/601

(57) ABSTRACT

The present invention is related to a vegetable oil composition having a balanced ratio polyunsaturated: saturated=ω6:ω3=1:1 with a balance of about 10%.

### FIELD OF THE INVENTION

The present invention is related to a new balanced vegetable “table” oil composition which is suitable for obtaining balanced dietary lipid diet for mammals, especially for humans and which presents unexpectedly an improved fragrance and stabilization against oxidation.

### BACKGROUND AND STATE OF THE ART

The International patent application WO 01/87091 describes an egg with balanced lipid composition having a lipid fraction balanced in seeds and green plant type Omega-6 and Omega-3 fatty acids according to the ratio of seeds and green plant type Omega-6 fatty acid seeds and green plant type Omega-3. (fatty acid=1:1+/−10%) and having a lipid fraction balanced between polyunsaturated and saturated fatty acid according to the ratio of polyunsaturated/saturated fatty acid=1:1+/10%.

However, an egg is an element of animal origin, which comprises specific lipids of animal origin such as cholesterol.

### AIMS OF THE INVENTION

The present invention aims to provide a compound of vegetable origin, which presents improved characteristics compatible with healthy diet for humans and animals.

A specific aim of the present invention is to provide a balanced vegetable oil composition, which does not present the drawbacks of the state of the art, in particular a balanced vegetable oil composition which presents an improved fragrance and stabilization against oxidation compared with the vegetable oil composition of the state of the art.

A last aim of the present invention is to propose such balanced vegetable oil composition and food composition comprising said balanced vegetable oil composition that may be consumed as part of a balanced diet in a reasonable quantity as recommended by national and international health foundations and that sustains consumers health in the long term.

### SUMMARY OF THE INVENTION

The inventors have discovered unexpectedly that it is possible to obtain a balanced vegetable oil composition (oil composition without animal lipids, such as cholesterol), hereafter called Columbus®oil and which presents improved organoleptic properties compared with known vegetable oil composition.

In particular, the inventors have discovered that is possible to obtain such composition, which unexpectedly presents an improved fragrance and stabilisation characteristics.

The present invention is related to a balanced vegetable oil composition wherein polyunsaturated fatty acids/saturated fatty acid ratio (P:S)=ω6 fatty acids/ω3 fatty acids ratio (ω6:ω3)=1:1 (with an allowance (balance) of about 10%, preferably of about 5%). Advantageously, in the composition according to the invention, the percentage of monounsaturated fatty acids (MUFAs) of said composition is higher than about 70% and the percentage of polyunsaturated fatty acids (PUFAs) is lower than about 30%, preferably the percentage of ω6 fatty acids in the composition is lower than about 10%, more preferably about 7%, while the percentage of ω3 fatty acids is higher than 5%, preferably about 7% (compared to the total percentage of lipids being 100%).

The composition according to the invention could also be further stabilized against oxidation by addition of a sufficient amount of (preferably natural) source of anti-oxidants (possibly naturally presenting other food ingredients such as eggs (WO 01/87091)) advantageously selected from the group consisting of vitamin C, vitamin E, polyphenols (including catechins, antocyanins, etc.), sulfur-containing antioxidants including glutothione and lipoic acid, and/or a mixture thereof in order to reach a stability against oxidation at least similar to the stability of olive oil.

The vegetable oil composition of the invention is advantageously obtained by a combination of about 80% to about 95% (preferably between about 85% to about 92%, preferably about 87% to about 90%, more preferably about 88%) of olive oil or canola oil (or any other vegetable oil which is advantageously low in ω6 fatty acids and about 5% to about 20%, preferably between about 7% and about 15%, preferably between about 9% and about 13%, more preferably about 12%) of flax oil, chia oil and/or perilla oil (or any other vegetable oil rich in ω3 fatty acids).

It is meant by a vegetable oil which is advantageously low in ω6 fatty acids, an oil wherein ω6 fatty acids concentration is lower than 30%, preferably lower than 20% (compared to the percentage of all lipids present in the composition).

It is meant by a vegetable oil which is rich in ω3 fatty acids, an oil wherein the ω3 fatty acids concentration (compared to all the lipids present in the composition) is higher than 40%, preferably higher than 50%, more preferably higher than 60%.

Another aspect of the present invention is also related to the use of said balanced vegetable oil in a “functional” food composition comprising a sufficient amount of said oil combined with other elements for obtaining dressing and/or cold/warm culinary delicacies, such as a mayonnaise, a spread, a salad, dressing, etc.

The present invention is also related to the functional food composition (mayonnaise, spread, salad, dressing, etc.) comprising usual food ingredients and a sufficient amount of said balanced vegetable oil composition for improving the organoleptic properties (improved fragrance) of said food composition and the functional characteristics of said food composition, especially for sustaining consumers health in the long term (possible reduction of cardiovascular diseases, of obesity and of cancer).

A last aspect of the invention concerns the method for obtaining the oil of the invention by mixing the two above mentioned oils in the percentages described above.

### EXAMPLES

### Example 1

### Columbus®Oil—Balanced Table Oil for Uses in Dressing and Cold/Warm Culinary Delicacies

Columbus®Oil (vegetable oil composition of the invention) typically is a mixture of vegetable oils that is formulated to deliver the balanced lipid composition (i.e. P:S=ω6:ω3=1:1) recommended by advanced nutritional sciences which recognize the need of a return to a dietary fatty acid standard reminiscent of that on which human has evolved on since its inception a couple of million years ago.

Modern oils are typically high in ω6 plant fatty acid (linoleic acid, (LA-C18): 2ω6) and typically low in ω3 plant fatty acids (alpha-linolenic acid, (LnA-C18):3ω3) with ω6:ω3 ratio's ranging all the way up from +/−50 to +/−500.

Only a few of them (wheat germ, soybean, walnut, canola), richer in ω3 fatty acids and with ω6:ω3 ratio's extending from +/−2 to +/−10, are now becoming commercially available.

Other oils very rich in ω3 fatty acids (flax, chia and perilla) with ω6:ω3 ratio's in the range of 0.3 to 0.2, are also presently brought to the attention of the consumer, but these oils are extremely rich in polyunsaturated fatty acids (PUFAS) (P:S OF 8 to 10) and are very sensitive to oxidation.

TABLE 1
Table oils characteristics currently available on
the market compared to the Columbus ® Oil of the invention

| | | MUFA | PUFA | | | Total | |
|---|---|---|---|---|---|---|---|
| Lipid Source | SAFA | ω7 + ω9 | ω6 | ω3 | ω6:ω3 | P:S | S + M + P |
| Sunflower | 13 | 27 | 61 | 0.1 | 610 | 4.7 | 101.1 |
| Peanut | 14 | 43 | 35 | 0.1 | 350 | 2.5 | 92.1 |
| Grapeseed | 14 | 21 | 68 | 0.5 | 136 | 4.9 | 103.5 |
| Corn | 16 | 32 | 51 | 1 | 51 | 3.2 | 100 |
| Palm | 51 | 40 | 9 | 0.25 | 36 | 0.2 | 100.25 |
| Olive (1) | 16 | 70 | 13 | 0.6 | 22 | 0.8 | 100.6 |
| Coconut | 92 | 7 | 1.5 | 0.1 | 15 | 0.02 | 100.6 |
| Olive (2) | 15 | 79 | 5 | 0.6 | 8 | 0.4 | 99.6 |
| Wheat germ | 20 | 18 | 55 | 7 | 8 | 3.1 | 100 |
| Soybean | 16 | 22 | 54 | 7.5 | 7 | 3.8 | 99.5 |
| Walnut | 11 | 15 | 62 | 12 | 5 | 6.7 | 100 |
| Canola | 7 | 63 | 20 | 10 | 2 | 4.3 | 100 |
| Columbus ® | 14 | 72 | 7 | 7 | 1 | 1.0 | 100 |
| Chia | 9.7 | 6.7 | 19 | 64 | 0.3 | 8.6 | 99.4 |
| Flax | 6.9 | 19.5 | 15 | 57.5 | 0.26 | 10.5 | 98.9 |
| Perilla | 8.5 | 14.4 | 12.6 | 63.2 | 0.20 | 8.9 | 98.7 |

SAFA = Saturated fatty acids
MUFA = Monounsaturated fatty acids
PUFA = Polyunsaturated fatty acids

With all these oils available, one may think that the consumer may end up by chance with a more or less balanced fatty acid ratio in his average diet, but this will clearly depends on the availability of each oil at the point of purchase and/or consumption and on the consumer awareness that these oils are complementary and must then be ingested in a appropriate manner.

Clearly, the adoption of a balanced dietary lipid diet remains a cumbersome exercise and there is therefore a need for an oil mixture that is providing a balanced composition in once.

The “Columbus Oil®” of the invention is preferably obtained through the combination of 88% olive oil (sample 2 low in ω6 fatty acids) and 12% flax oil to obtain an oil mixture that is perfectly balanced in polyunsaturated, saturated, ω6 and ω3 fatty acids, while being one of the richest source of monounsaturated fatty acids (MUFAs) (M:72%) as recommended by advanced nutritional guidelines (P:M:S=1:6:1).

It is obvious that this specification may be obtained and/or approached through various other combinations like those of olive and/or canola oils with chia and/or perilla oils.

Preferably, the balanced mixture of oils is further stabilized (if necessary) against oxidation with a natural source of antioxidants such as vitamin C, vitamin E. polyphenols (including catechins, antocyanins, etc.), sulfur-containing antioxidants including glutothione and lipoic acid, and/or mixtures of those to reach a stability at least similar to that of olive oil.

Interestingly, the ω6:ω3 ratio in Columbus®Oil is similar to that of essential fatty acids in wild-type river and marine fishes (table 2). However, fishes are also rich in long-chain polyunsaturated fatty acids (LC-PUFAs) which brings the P.S ratio towards much higher values characteristic of very oxidation-sensitive oils.

TABLE 2
Columbus ® Oil vs fish oils

| | | MUFA | PUFA | | | Total | |
|---|---|---|---|---|---|---|---|
| Lipid Source | SAFA | ω7 + ω9 | ω6 | ω3 | ω6:ω3 | P:S | S + M + P |
| Columbus ® | 14 | 72 | 7 | 7 | 1 | 1.0 | 100 |
| Salmon | 20 | 30 | 5 | 5 | 1 | 2.5* | 60* |
| Trout | 25 | 30 | 6 | 6 | 1 | 1.8* | 67* |

*calculated as (100 − (SAFA + MUFA)/SAFA to take account of the contribution of LC-PUFA of fish (salmon and trout) not accounted for in the table.

### Example 2

### Improved Fragrance and Stabilisation Characteristics of the Columnbus®Oil

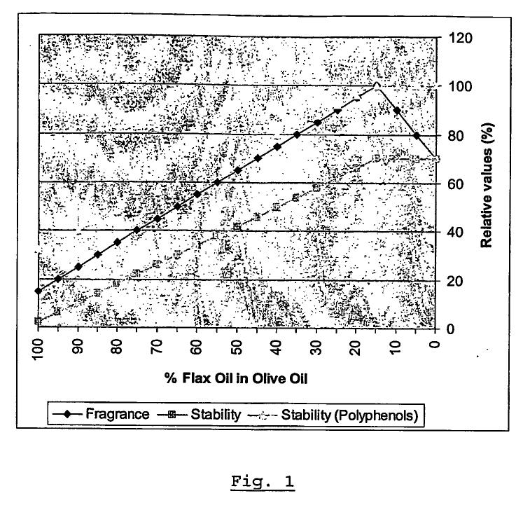

The enclosed FIG. 1 shows that olive oil has a typical fragrance and a good stability characteristics but not an optimised ω6/ω3 ratio.

The inventors have observed unexpectedly that the addition (up to 15%) of an oil rich in ω3, for instance a flax seed oil (fso) to olive oil (oo) increases the fragrance of olive oil without reducing the stability of the composition.

The inventors have also observed that the improving of said fragrance is not maintained when the concentration of the added oil rich in ω3 is higher than 15%, a decrease of the stability is also observed simultaneously. Therefore, the composition of the invention is characterised by a synergic effect of the two mixed oils that result unexpectedly in a new composition characterised by improved organoleptic properties, while presenting an optimised P:S=0)ω6:ω3 ratio (12% of flax seed oil, 88% of olive oil).

Furthermore, the inventors have shown that the composition according to the invention can be further stabilised by the addition of antioxidants, such as polyphenols, in order to obtain balanced vegetable oil characterized by a unique outstanding stability and fragrance. Said stabilisation reaches 100% compared to the relative stability of olive oil.

### Example 3

### Mayonnaise Composition

Potassium sorbate (about 0,05%), sugar (about 3%) and corn starch (about 3%) are dispersed in water and mixed with salt (about 1,5%) and vinegar (about 6%).

The mixture is heated up to about 85° C. in order to form a paste which is thereafter mixed with the Colombus®oil of the invention (about 80%).

To this mixture, add egg yolk preferably from an egg (WO 01/87091) having also an optimum ω6:ω3 ratio) The mixture is thereafter submitted to an aeration step before the addition of mustard and before conditioning.

The obtained mayonnaise presents improved organoleptic properties and an optimum ω6:ω3 ratio suitable for sustaining consumer health in the long term.

### Example 4

### Spread Composition

Mix salt (about 0,5%) potassium sorbate (about 0,5%) in water (about 19%). Heat the aqueous phase up to 80° C. and cool slowly the mixture at the temperature of about 45° C. Add slowly the aqueous phase to the mixture of Colombus®oil (about 79,5%) and emulsifiant (about 0,5%) with important mixing force to form an emulsion. Cool the mixing at a temperature of about 10° C. in a schr\ddot{0}der apparatus and maintain at low temperature the obtained spread having improved organoleptic characteristics.

1. A vegetable oil composition having a balanced ratio polyunsaturated fatty acids (P): saturated fatty acids (S)=ω6 fatty acids: ω3=1:1 with an allowance of about 10%.

2. The composition according to claim 1, wherein the percentage of monounsaturated fatty acids (MUFA) is higher than 70% and wherein the percentage of polyunsaturated fatty acids (PUFA) is lower than 30%.

3. The composition according to claim 2, wherein the percentage of ω6 fatty acids is lower than 10% and the percentage of ω3 fatty acids in the composition is higher than 5%.

4. The composition according to claim 3, wherein the percentage of ω6 and the percentage of ω3 are about 7%.

5. The composition according to claim 1, further comprising an anti-oxidant.

6. The composition according to claim 5, wherein the anti-oxidant is selected from the group consisting of vitamin C, vitamin E, polyphenols including catechins, antocyanins, sulfur-containing antioxidants including glutothione and lipoic acid, and/or a mixture thereof.

7. The composition according to claim 1, comprising:
about 80% to about 95% of an oil selected from the group consisting of olive oil and/or canola oil; and
about 5% to about 20% of an oil selected from the group consisting of flax oil, chia oil and/or perilla oil.

8. The composition according to of claim 7, comprising about 88% of an oil selected from the group consisting of olive oil and/or canola oil and about 12% of an oil selected from the group consisting of flax oil, chia oil and/or perilla oil.

9. The composition according to claim 1, comprising about 14% of saturated fatty acids, about 72% of ω7 fatty acids+ω9 monounsaturated fatty acids, about 7% of ω6 polyunsaturated fatty acids, about 7% of ω3 polyunsaturated fatty acids, with a ratio ω6:ω3=about 1:1, a ratio Polyunsaturated: Saturated fatty acids P:S=about 1.0, and wherein the total amount of saturated, monunsaturated and polyunsaturated fatty acids (S+M+P)=100%.

10. A food composition comprising in addition to usual ingredients a sufficient amount of the oil composition according to claim 1.

11. The food composition of claim 10 which is selected from the group consisting of a mayonnaise, a spread or a salad dressing.

12. A method for obtaining the vegetable oil composition of claim 1 to 8, wherein a first oil having a ω6 fatty acid content lower than 30% is mixed with a second oil having a ω3 fatty acid content higher than 50%, in a proportion comprised between about 80% and 95% of the first oil and comprised between about 9% and 20% of the second oil.

13. The method of claim 12, wherein the first oil has a ω6 fatty acid content lower than 20%.

14. The method of claim 12, wherein the second oil has a ω3 fatty acid content higher than 60%.

15. The method of claim 12, wherein the first oil is olive oil and/or canola oil and wherein the second oil is selected from the group consisting of flax oil, chia oil and/or perilla oil.
